(19) United States
(12) Patent Application Publication
(10) Pub. No.: US 2022/0327354 A1
(43) Pub. Date: Oct. 13, 2022

(54) RAPID, ENERGY-SAVING, ITERATIVE OPERATION OF ARTIFICIAL NEURAL NETWORKS

(71) Applicant: Robert Bosch GmbH, Stuttgart (DE)

(72) Inventors: Thomas Pfeil, Kornwestheim (DE); Thomas Elsken, Sindelfingen (DE)

(21) Appl. No.: 17/658,314

(22) Filed: Apr. 7, 2022

(30) Foreign Application Priority Data
Apr. 13, 2021 (EP) 21 16 8181.2

(51) Int. Cl. G06N 3/04; G06N 3/063; G06N 3/08; G05B 13/02; B60W 50/00

(52) U.S. Cl. CPC G06N 3/04; G06N 3/063; G06N 3/08; G05B 13/027; B60W 50/00

(57) ABSTRACT

A method for operating an artificial neural network (ANN), which processes inputs in a sequence of layers, to give outputs. In the method: within the ANN, at least one iterative block comprising one or more layers is defined and is to be executed multiple times; a number J of iterations is defined; an input of the iterative block is mapped onto an output by the iterative block; the output is supplied to the iterative block again as an input and is mapped onto a new output; once the iterative block has been executed J times, the output delivered by the iterative block is supplied, as an input, to the layer of the ANN succeeding the iterative block or is provided as the output of the ANN. A portion of the parameters that characterize the behavior of the layers in the iterative block are changed between the iterations.

### CROSS REFERENCE

The present application claims the benefit under 35 U.S.C. § 119 of European Patent Application No. EP 21 16 8181.2 filed on Apr. 13, 2021, which is expressly incorporated herein by reference in its entirety.

### FIELD

The present invention relates to the operation of artificial neural networks, in particular under the constraint of limited hardware and energy resources on board vehicles.

### BACKGROUND INFORMATION

Typically, training for driving a vehicle on the roads by a human driver is performed by repeatedly confronting a learner driver with a specific compilation of situations in the course of their training. The learner driver has to react to each of these situations, and is given feedback on whether their reaction was correct or incorrect by comments or even an intervention by the driving instructor. This training with the aid of a finite number of situations is intended to enable the learner driver to master even unfamiliar situations when they drive the vehicle independently.

So that vehicles may become part of traffic on the roads with partial or full automation, it is sought to control them with the aid of neural networks that can be trained in an entirely similar manner. These networks receive, for example, sensor data from the vehicle environment as inputs, and deliver control signals which can be used to intervene in operation of the vehicle, as outputs, and/or intermediates from which such control signals are formed. For example, a classification of objects in the environment around the vehicle, and/or a semantic segmentation of the environment around the vehicle, may be an intermediate of this kind.

### SUMMARY

In the context of the present invention, a method is provided for operating an artificial neural network, ANN. The ANN processes inputs in a sequence of layers, to give outputs. These layers may be for example convolution layers, pooling layers or fully connected layers.

Inputs to the ANN may comprise in particular, for example, measurement data that were captured by one or more sensors. The outputs of the ANN may comprise, for example, one or more classification scores, which are used to express the association of the measurement data with one or more classes of a specified classification.

In accordance with an example embodiment of the present invention, within the ANN, at least one iterative block comprising one or more layers is defined. In the course of processing a concrete set of inputs to give a concrete set of outputs, this iterative block is to be executed multiple times.

For this purpose, a number J of iterations is defined, which is the maximum number of times the iterative block is to be executed. Then, an input of the iterative block is mapped onto an output by the iterative block. This output is supplied to the iterative block again as an input and is, in its turn, mapped onto a new output by the iterative block. Once the iterations of the iterative block have been completed, the output delivered by the iterative block is supplied, as an input, to the layer of the ANN succeeding the iterative block. By contrast, once no more layers of the ANN succeed the iterative block, this output is provided as the output of the ANN.

The number J of the maximum number of iterations to be executed may be defined, for example, with reference to the available hardware resources and/or processing time. However, it is also possible for the iterations to be ended early if a specified abort criterion is met. For example, the iteration may be ended if the output from the iterative block has converged sufficiently well to a final result.

Because the iterative block is executed multiple times, in the course of processing a concrete input of the ANN to give a concrete output of the ANN the hardware on which the iterative block is implemented will be passed through multiple times. For this reason, a specified processing task can be performed using fewer hardware resources than if the data passed through the hardware only once, in one direction. Thus, the hardware may be of smaller overall construction, which is advantageous in particular with control devices for vehicles.

In accordance with an example embodiment of the present invention, one or more parameters that characterize the behavior of the layers in the iterative block are changed at the time of switching between the iterations for which the iterative block is executed. During this, parameters that characterize the behavior of the layers in the iterative block are defined or modulated on the basis of the output of an auxiliary ANN. This auxiliary ANN receives the following as inputs:
An input of the iterative block, and/or
The parameters that characterize the behavior of the layers in the iterative block, and/or
A processing product that is formed in a layer of the ANN which is downstream of the iterative block, and/or
A continuous index of the iteration currently being executed by the iterative block.

In this context, “modulate” is understood in particular, for example, to mean that a parameter is not defined completely afresh, divorced from its history, but that it is further developed from this history and in correspondence with it. For example, the parameter may fluctuate about a mean value.

In accordance with the present invention, it was seen that the auxiliary ANN may model very complex functions for changing the parameters at the time of switching between the iterations, in a very compact form. This greater flexibility in turn has the effect that the iterative block can take a significantly smaller form—that is to say with significantly fewer neurons or other processing units—and still fulfill its function well as regards the relevant application. The cause of this is that the graph which is formed from the neurons or other processing units of the iterative block and which the data that are input into the ANN have to pass through may be significantly smaller as a result of the more flexible adaptation of the parameters.

This in turn makes it easier, during execution of the iterative block on a processor, such as a CPU or an FPGA, to manage using the respective internal memory of this processor, without the need to resort to an external random access memory (such as DDR-RAM). Memories internal to the processor, such as cache memory and, in particular, registers, can be accessed orders of magnitude more quickly than DDR-RAM, for example, but on the other hand can store orders of magnitude less data. At the same time, access to the memories internal to the processor is significantly more energy-efficient, because there is no need to send signals over external lines.

Moreover, changing the parameters on the basis of the output of the auxiliary ANN is particularly advantageous in that an auxiliary ANN of this kind is particularly well able to usefully combine different inputs of data of entirely different types to give one output. For example, a processing product that is formed in a layer of the ANN which is downstream of the iterative block may be combined with the input of the iterative block. The processing product may be for example the output from the ANN as a whole. In the case of an ANN used as an image classifier, this output may be, for example, a vector of classification scores relating to different classes. The input of the iterative block, by contrast, may then comprise for example one or more feature maps which are formed by convolution layers and which were generated by applying filter kernels.

Executing the auxiliary ANN results in an additional cost. This auxiliary ANN is, however, typically significantly smaller than the iterative block. Thus, ultimately the savings made by the possible reduction in size of the iterative block outweigh this.

In a particularly advantageous specific example embodiment of the present invention, new values of the parameters of the iterative block, and/or updates to these parameters, are defined with the aid of a differentiable function of the output of the auxiliary ANN. This makes it easier to train the auxiliary ANN, together with the actual ANN, to the common final objective specified by the respective application. Taking as a starting point assessment of the ultimate output of the ANN with a cost function (loss function), gradients of the parameters of the iterative block can then be backpropagated seamlessly to the auxiliary ANN. Where the transfer from the auxiliary ANN to the parameters of the iterative block cannot be differentiated, a differentiable approximation is needed for this backpropagation.

In a further particularly advantageous specific example embodiment of the present invention, at least one parameter of the iterative block is modulated by executing a machine command that is quicker to execute on the hardware platform used for this than it would be to set this parameter to any desired value. Examples of operations of this kind are incrementing, decrementing, and bitwise offset, which has the effect of multiplying or dividing by a power of two. In this way, adaptation of the parameters of the iterative block between iterations is speeded up.

In a further particularly advantageous specific example embodiment of the present invention, only a portion of the parameters that characterize the behavior of the layers in the iterative block are changed at the time of switching between the iterations for which the iterative block is executed. Not all the parameters are changed, nor are all the parameters left unchanged. The flexibility that is brought about by changing the parameters in the iterative block is not without cost, but always takes some time and energy.

It was seen that, starting from the condition in which all the parameters remain unchanged, changing just a few parameters brings about a gain in flexibility that significantly reduces the required size of the ANN and at the same time, such as in the case of classifiers, significantly improves the accuracy of classification. Nonetheless, a need for more energy and/or time for changing these few parameters between the iterations is not yet significant. As a first approximation, for each additionally changed parameter, the gain in flexibility brings about a certain quantum of advantageous effect, which is particularly great for the first changed parameters and then falls off relatively quickly until it reaches saturation point. By contrast, the cost in terms of energy and/or speed for each additionally changed parameter is constant, as a first approximation. For this reason, at a certain number of changed parameters a break-even is reached, after which changing more parameters is disadvantageous rather than advantageous.

For this reason, in a particularly advantageous specific example embodiment of the present invention, starting from at least one iteration, a proportion of between 1% and 20%, preferably between 1% and 15%, of the parameters that characterize the behavior of the layers in the iterative block are changed at the time of switching to the next iteration.

In a further advantageous specific example embodiment of the present invention, at the time of a first switch between iterations, a first portion of the parameters is changed, and at the time of a second switch between iterations a second portion of the parameters is changed. In this context, the second portion is not congruent with the first portion. However, the two portions may each comprise the same number of parameters. In this way, the iteratively executed block may gain even more flexibility without this being at a cost of even more time or energy.

In a further particularly advantageous specific example embodiment of the present invention, an ANN is selected which at first processes inputs with the aid of a plurality of convolution layers, and which, from the result obtained, with the aid of at least one further layer determines at least one classification score relating to a specified classification. The iterative block is then defined such that it comprises at least a portion of the convolution layers. As a result, by comparison with the implementation of an ANN that is passed through only once and in only one direction, it is possible to make a particularly large saving on hardware. In this context, it is particularly advantageous if the first convolution layer to which the inputs of the ANN are supplied is not yet part of the iterative block. In that case, in this convolution layer there is still the maximum flexibility for usefully reducing the dimensionality of the input. Thus, the number of processing operations required for this is not yet increased by the iterative execution. In the further, iteratively executed convolution layers, successive features from the inputs can subsequently be extracted before the classification score is determined, for example with the aid of a fully connected layer, from these features.

The inputs may in particular be, for example, image data and/or time series data. It is specifically these data types that have a particularly large dimensionality, with the result that processing using iteratively executed convolution layers is particularly advantageous.

As explained above, at least the iterative block of the ANN may be executed on at least one processor using machine commands that exclusively access an internal memory of this processor. This processor may be in particular, for example, a CPU or an FPGA. In that case, in particular there may be selected as the internal memory for example a register memory and/or a cache memory.

An existing, fully trained ANN may be implemented on a lift-and-shift basis without new training such that it can be operated using the method described here. However, the ANN delivers even better results if it can already be adapted at the time of training to being operated using this method. For this reason, the present invention also relates to a method for training an ANN for operation by the method described above.

In this method, learning inputs, and associated learning outputs onto which the ANN is to map the respective learning inputs, are provided. The learning inputs are mapped onto outputs by the ANN. The discrepancy between the outputs and the learning outputs is assessed using a specified cost function.

The parameters that characterize the behavior of the layers in the iterative block, including their changes at the time of switching between iterations, and/or parameters that characterize the behavior of the auxiliary ANN are optimized such that, on further processing of learning inputs by the ANN, the assessment by the cost function is expected to have improved.

Here, within certain limits, the extent to which the parameters of the iterative block are defined by the auxiliary ANN, and the extent to which parameters of the iterative block can also still be changed independently of the auxiliary ANN, are selectable. If the parameters of the iterative block are defined entirely by the auxiliary ANN, only the parameters of the auxiliary ANN need be optimized. If the parameters of the iterative block can also still be changed independently of the auxiliary ANN, the optimization should also extend to these possible independent changes.

In this way, in particular for example a specified number of parameters that is to be changed at the time of switching between the iterations may be utilized such that, with the aid of the flexibility gained in this way, the ANN achieves the best possible performance in respect of the trained task.

However, for example, an additional purpose of the optimization may also be which and/or how many parameters that characterize the behavior of the layers in the iterative block are to be changed at all at the time of switching between iterations. For this purpose, for example the cost function may include a contribution that depends on the number of parameters that is changed at the time of switching between iterations, the rate of change of these changed parameters, and/or the absolute or relative change over all parameters. In this way, it is possible, for example, to balance the advantage which is brought about by the gain in flexibility from additionally changing a parameter, against the cost of energy and time for this change.

This contribution may, for example, take the following form:

$$L = {\sum }_{j}^{J - 1} {\sum }_{i}^{I} ‖ {w}_{i}^{j} , {w}_{i}^{j + 1} ‖$$

Here, wᵢ^{j} are the parameters that characterize the behavior of the layers in the iterative block. The subscript i designates the individual parameters, and the superscript j designates the iterations. I designates the total number of parameters present, and J designates the total number of iterations. Thus, L is the measure of the absolute or relative change over all parameters to a desired standard, such as an L₀ standard, an L₁ standard, an L₂ standard or an L₃ standard. An L₀ standard is a measure of the number of parameters that change.

In a further advantageous specific example embodiment of the present invention, at the same time as and/or in alternation with the parameters that characterize the behavior of the layers in the iterative block, it is also possible for further parameters, which characterize the behavior of further neurons and/or other processing units of the ANN outside the iterative block, to be optimized to an assessment by the cost function that is expected to be better. Then, for example the parts of the ANN that are not executed iteratively can at least partly compensate for the losses in accuracy that the sacrifice in flexibility made in the iterative block of the ANN brings about.

As explained above, the iterative execution of parts of an ANN is particularly advantageous on board vehicles, where both additional space for hardware and also energy from the onboard circuitry of the vehicle are limited resources.

Thus, the present invention also relates to a control device for a vehicle. This control device comprises an input interface, which can be connected to one or more sensors of the vehicle, and an output interface, which can be connected to one or more actuators of the vehicle. Furthermore, the control device comprises an ANN. This ANN takes part in the processing of measurement data obtained over the input interface by the sensor or sensors to give a control signal for the output interface. Moreover, this ANN is configured for performing the method described in the introduction. In this environment, the saving on both hardware resources and on energy that was discussed above is particularly advantageous.

The methods may in particular be entirely or partly computer-implemented. Thus, the present invention also relates to a computer program having machine-readable instructions that, when they are executed on one or more computers, cause the computer or computers to perform one of the described methods. In this context, control devices for vehicles and embedded systems for technical devices that are also capable of executing machine-readable instructions are also to be regarded as computers.

Likewise, the present invention also relates to a machine-readable data carrier and/or to a download product comprising the computer program. A download product is a digital product that is transmissible over a data network—that is to say can be downloaded by a user of the data network—and may be offered for sale for example by an online shop, for immediate download.

Moreover, a computer may be equipped with the computer program, the machine-readable data carrier or the download product.

Further measures that improve the present invention are presented in more detail below with reference to figures, in conjunction with the description of the preferred exemplary embodiments of the present invention.

### BRIEF DESCRIPTION OF THE DRAWINGS

FIG. 1 shows an exemplary embodiment of the method 100 for operating the ANN 1, in accordance with the present invention.

FIG. 2 shows an exemplary implementation of the method 100 in a classifier network, in accordance with the present invention.

FIG. 3 shows an exemplary embodiment of the method 200 for training the ANN 1, in accordance with the present invention.

FIG. 4 shows an exemplary embodiment of the control device 51 for a vehicle 50, in accordance with the present invention.

FIG. 5 illustrates the advantage of changing only a few parameters of the iterative block, in accordance with the present invention.

### DETAILED DESCRIPTION OF EXAMPLE EMBODIMENTS

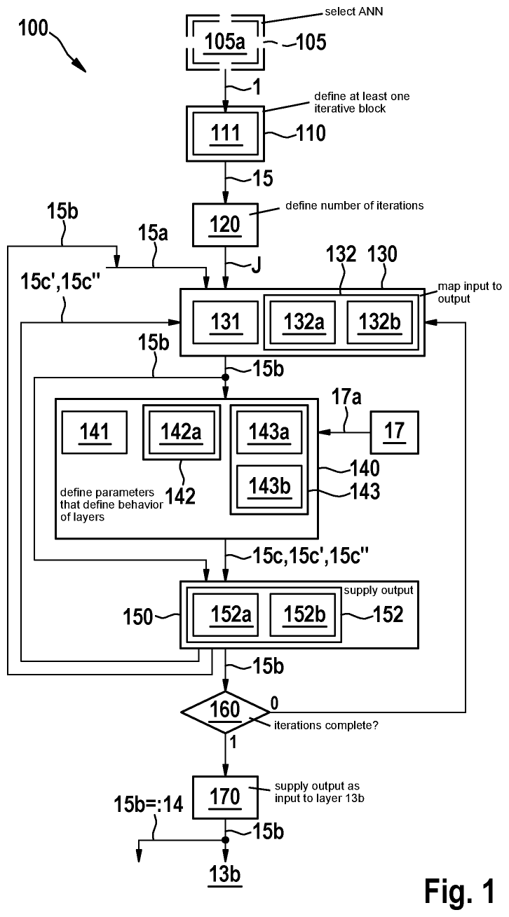

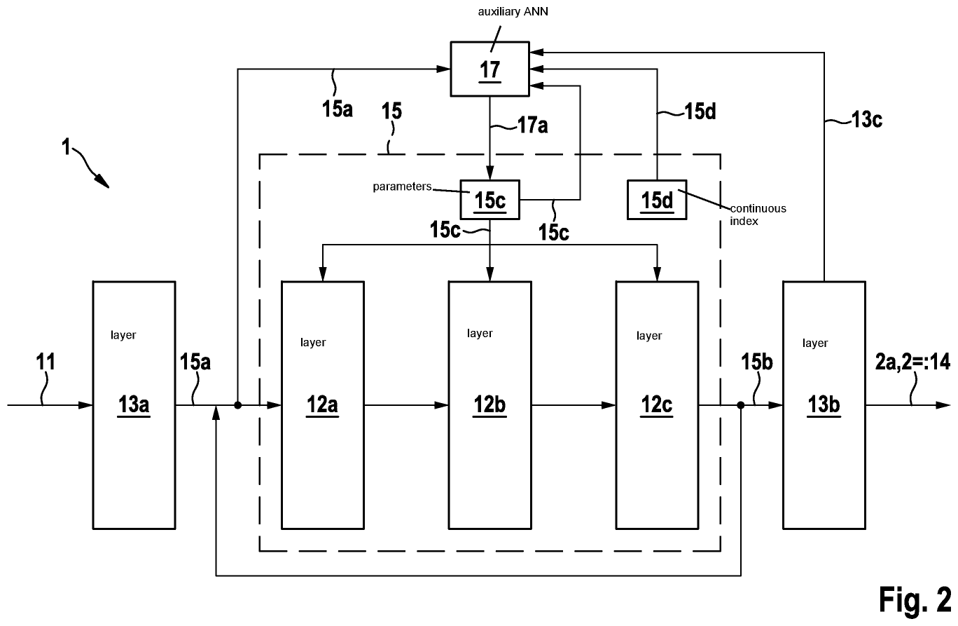

FIG. 1 is a schematic flow diagram of an exemplary embodiment of the method 100 for operating the ANN 1. The ANN 1 comprises a sequence of layers 12a-12c, 13a-13b, with the aid of which inputs 11 are processed to give outputs 14. These layers are presented in more detail in FIG. 2.

Within the ANN 1, in step 110 at least one iterative block 15 which comprises one or more layers 12a-12c and which is to be executed multiple times is defined. In step 120, a number J of iterations is defined for which this iterative block 15 is to be executed.

In accordance with the architecture of the ANN 1, the iterative block 15 receives a particular input 15a. In step 130, the iterative block 15 maps this input 15a onto an output 15b. Here, the behavior of the iterative block 15 is characterized by parameters 15c. These parameters 15c may be, for example, weights, which are applied to inputs that are supplied to a neuron or another processing unit of the ANN 1 in order to activate this neuron or other processing unit.

In step 140, parameters 15c that characterize the behavior of the layers 12a-12c in the iterative block 15 are defined or modulated using the output 17a from an auxiliary ANN 17. Here, this auxiliary ANN 17 receives the following as inputs:
An input 15a of the iterative block 15, and/or
A processing product 13c that is formed in a layer 13b of the ANN 1 which is downstream of the iterative block 15, and/or
The parameters 15c that characterize the behavior of the iterative block 15, and/or
A continuous index 15d of the iteration currently being executed by the iterative block 15.

Here, in particular according to, for example, block 141, new values of the parameters 15c, and/or updated values of these parameters 15c, may be defined with the aid of a differentiable function of the output 17a of the auxiliary ANN 17.

According to block 142, in particular, for example at least one parameter 15c may be modulated by executing a machine command that is quicker to execute on the hardware platform used for this than it would be to set this parameter 15c to any desired value. The operation brought about by this machine command may in particular, according to block 142a, be for example an incrementing, a decrementing, or a bitwise offset.

According to block 143, for example only a portion 15c′ of the parameters 15c may be changed before the iterative block 15 is executed in the next iteration. Thus, not all the parameters 15c are unchanged, nor are all the parameters 15c changed.

In order to execute the next iteration, in step 150 the output 15b generated previously by the iterative block 15 is supplied to the iterative block 15 again, as input 15a.

In step 160, a check is carried out as to whether the iterations of the iterative block 15 were completed. The iterations have been completed if J iterations have already been passed through, or if another specified abort criterion is met, whichever occurs first. If the iterations have not yet been completed (truth value 0), then for the purpose of changing a portion 15c′ of the parameters there is a branch back to step 140 and a further iteration is subsequently passed through in step 150. If, on the other hand, the iterations have been completed (truth value 1), then in step 170 the output 15b from the iterative block 15 is supplied as an input of the layer 13b of the ANN 1 which succeeds the iterative block 15. If there are no more succeeding layers 13b of this kind, on the other hand, the output 15b of the iterative block 15 is provided as an output 14 of the ANN 1.

Optionally, in step 105 it is possible to select an ANN 1 which at first processes inputs 11 with the aid of a plurality of convolution layers 13a, 12a-12c, and which, from the result obtained, with the aid of at least one further layer 13b determines at least one classification score 2a relating to a specified classification 2 as the output 15. According to block 111, the iterative block 15 can then be defined such that it comprises at least a portion 12a-12c of the convolution layers 13a, 12a-12c. This is presented in more detail in FIG. 2.

In particular, for example according to block 105a, image data and/or time series data may be selected as inputs 11 of the ANN 1.

The mapping of an input 15a of the iterative block 15 onto an output 15b may, according to block 131, in particular include for example adding up inputs that are supplied to neurons and/or other processing units in the iterative block, with weightings with the aid of analog electronics (multiply and accumulate, MAC).

According to block 132 and/or 152, it is possible in particular, for example, to execute at least the iterative block 15 of the ANN 1 on at least one processor, using machine commands which exclusively access an internal memory of this processor. Here, in particular, for example according to block 132a and/or 152a, a CPU or an FPGA may be selected as the processor. According to block 132b and/or 152b, there may be selected as the internal memory in particular, for example, a register memory and/or a cache memory.

According to block 143a, in particular, for example, a proportion 15c′ of between 1% and 20%, preferably between 1% and 15%, of the parameters 15c that characterize the behavior of the layers 12a-12c in the iterative block 15 may be changed at the time of switching to the next iteration.

According to block 143b, at the time of a first switch between iterations a first portion 15c′ of the parameters 15c is changed, and at the time of a second switch between iterations a second portion 15c″ of the parameters 15c is changed. In this context, the second portion 15c″ is not congruent with the first portion 15c′.

FIG. 2 shows an exemplary implementation of the method on a classifier network, as ANN 1. The ANN 1 receives measurement data, as inputs 11, and outputs classification scores 2a for these measurement data in relation to a specified classification 2, as outputs 14.

For this purpose, in a first convolution layer 13a the dimensionality of the measurement data is reduced before, in further convolution layers 12a-12c, successive features are recognized in the measurement data. This further recognition of features may take place, for example, at the same time as or successively at different size scales.

The further convolution layers 12a-12c are grouped together to form the iterative block 15, which receives its input from the first convolution layer 13a and is executed multiple times. In so doing, the output 15b of one iteration is used in each case as the input 15a for the next iteration.

Once the iterations of the iterative block 15 have been completed, the output 15b from the iterative block 15 is forwarded to the fully connected layer 13b, where the classification scores 2a are formed. As an alternative, it is also possible for a classification score 2a to be calculated on each iteration.

In addition, an auxiliary ANN 17 is provided in order to define or modulate, on the basis of the output 17a of this auxiliary ANN 17, parameters 15c which characterize the behavior of the layers 12a-12c in the iterative block 15. In the example that is shown in FIG. 2, the following are supplied as inputs to the auxiliary ANN 17:
An input 15a of the iterative block 15, and/or
A processing product 13c that is formed in a layer 13b of the ANN 1 which is downstream of the iterative block 15, and/or
The parameters 15c that characterize the behavior of the iterative block 15, and/or
A continuous index 15d of the iteration currently being executed by the iterative block 15.

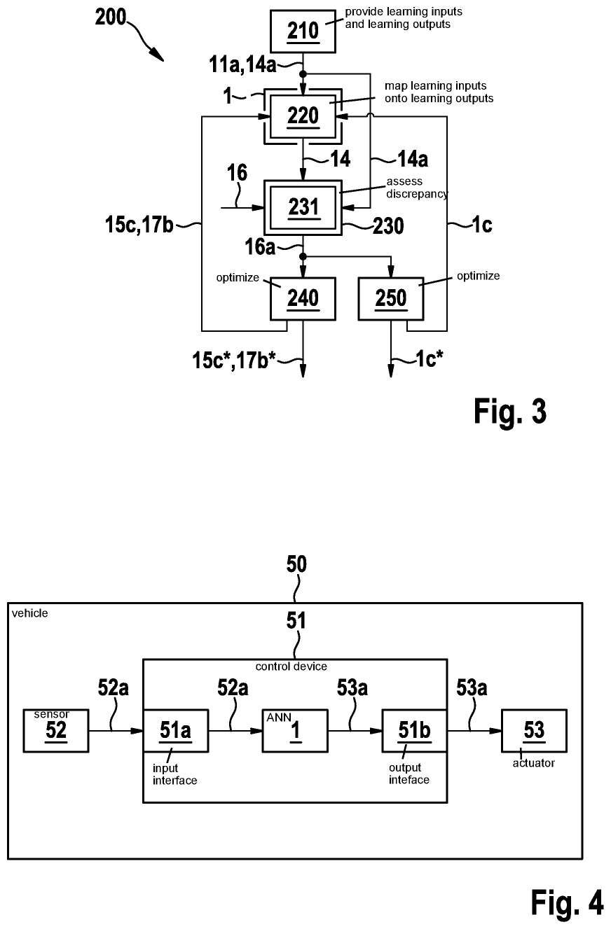

FIG. 3 is a schematic flow diagram of an exemplary embodiment of the method 200 for training the ANN 1.

In step 210, learning inputs 11a and associated learning outputs 14a, onto which the ANN 1 is to map the respective learning inputs 11a, are provided. These learning inputs 11a are mapped onto outputs 14 by the ANN 1, in step 220. The discrepancy between the outputs 14 and the learning outputs 14a is assessed in step 230 with the aid of a specified cost function 16.

In step 240, the parameters 15c that characterize the behavior of the layers 12a-12c, 13a in the iterative block 15, including their changes at the time of switching between the iterations, and/or parameters 17b that characterize the behavior of the auxiliary ANN 17, are optimized such that, on further processing of learning inputs 11a by the ANN 1, the assessment 16a by the cost function 16 is expected to have improved.

In step 250, at the same time as or in alternation with this, further parameters 1c that characterize the behavior of further neurons and/or other processing units of the ANN 1 outside the iterative block 15 are optimized to give an assessment 16a by the cost function 16 that is expected to be better.

The fully trained state of the parameters 15c is designated by the reference character 15c*. The fully trained state of the parameters 17b is designated by the reference character 17b*. The fully trained state of the parameters 1c is designated by the reference character 1c*.

FIG. 4 shows an exemplary embodiment of the control device 51 for a vehicle 50. The control device 51 includes an input interface 51a that, in this case, is connected to a sensor 52 of the vehicle 50 and receives measurement data 52a from this sensor 52. The measurement data 52a are processed, with the aid of an ANN 1, to give a control signal 53a which is provided for an actuator 53 of the vehicle 50. The control signal 53a is forwarded by way of an output interface 51b of the control device 51 to which the actuator 53 is connected.

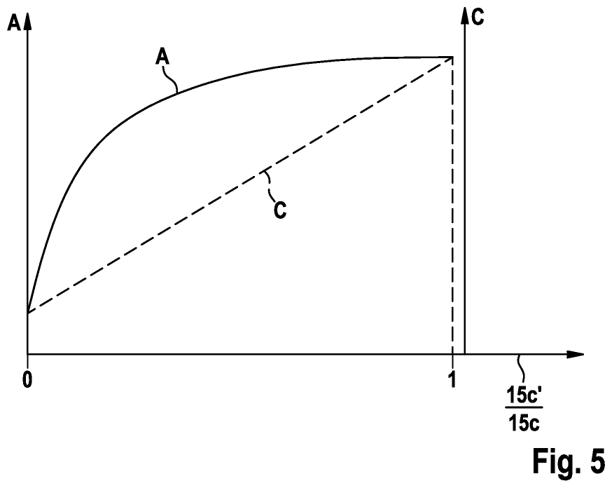

FIG. 5 illustrates schematically the advantage brought about by changing, at the time of switching between iterations, only a portion 15c′ of the parameters 15 which characterize the behavior of the iterative block 15. The classification accuracy A of an ANN 1 that is used as a classifier network, and the energy costs C for operating this ANN 1, are both shown over the quotient 15c′/15c of the number of changed parameters 15c′ and the total number of parameters 15c present.

Certain energy costs C occur even if no parameters 15c are changed. Starting from this base amount, the energy costs C increase linearly with the number of changed parameters 15c′. However, the classification accuracy A does not increase linearly. It increases particularly sharply if just a few parameters 15c′ are changed. This rate of growth lessens as the number of changed parameters 15c′ increases, and at some stage reaches a saturation point. It is thus advantageous for a low level of additional energy costs C to utilize the initial, large rise in the classification accuracy A.

What is claimed is:

1. A method for operating an artificial neural network (ANN), which processes inputs in a sequence of layers, to give outputs, the method comprising the following steps:
defining, within the ANN, to be executed multiple times, at least one iterative block including one or more layers;
defining number J of iterations, which is a maximum number of times the iterative block is to be executed;
mapping an input of the iterative block onto an output, by the iterative block;
supplying the output of the iterative block to the iterative block again as the input of the iterative bock, which is, in turn, mapped onto a new output by the iterative block;
supplying by the iterative block, once the iterations of the iterative block have been completed, the output delivered by the iterative, as an input, to a layer of the ANN succeeding the iterative block or as the output of the ANN;
wherein parameters that characterize a behavior of the layers in the iterative block are defined or modulated based on output of an auxiliary ANN that receives the following as inputs:
the input of the iterative block, and/or
a processing product that is formed in a layer of the ANN which is downstream of the iterative block, and/or
the parameters that characterize the behavior of the layers of the iterative block, and/or
a continuous index of the iteration currently being executed by the iterative block.

2. The method as recited in claim 1, wherein new values of the parameters that characterize the behavior of the layers in the iterative block, and/or updates to the parameters that characterize the behavior of the layers in the iterative block are defined using a differentiable function of the output of the auxiliary ANN.

3. The method as recited in claim 1, wherein at least one of the parameters that characterize the behavior of the layers in the iterative block is modulated by executing a machine command that is quicker to execute on a hardware platform used for this purpose than it would be to set the parameter to any desired value.

4. The method as recited in claim 3, wherein the at least one of the parameters that characterize the behavior of the layers in the iterative block is modulated by incrementing, or decrementing, or bitwise offset.

5. The method as recited in claim 1, wherein only a portion of the parameters that characterize the behavior of the layers in the iterative block are changed at the time of switching between the iterations for which the iterative block is executed.

6. The method as recited in claim 5, wherein, starting from at least one iteration, a proportion of between 1% and 20% of the parameters that characterize the behavior of the layers in the iterative block are changed at the time of switching to the next iteration.

7. The method as recited in claim 6, wherein the proportion is between 1% and 15%.

8. The method as recited in claim 5, wherein, at the time of a first switch between iterations, a first portion of the parameters that characterize the behavior of the layers in the iterative block is changed, and at the time of a second switch between iterations a second portion of the parameters that characterize the behavior of the layers in the iterative block is changed, the second portion not being congruent with the first portion.

9. The method as recited in claim 1, wherein the ANN is selected which at first processes inputs using a plurality of convolution layers, and which, from a result obtained, using at least one further layer determines at least one classification score relating to a specified classification as the output, the iterative block being defined such that the iterative block includes at least a portion of the convolution layers.

10. The method as recited in claim 9, wherein image data and/or time series data are selected as the inputs of the ANN.

11. The method as recited in claim 1, wherein at least the iterative block of the ANN is executed on at least one processor using machine commands that exclusively access an internal memory of the processor.

12. The method as recited in claim 11, wherein the processor is a CPU or an FPGA, and wherein the internal memory is a register memory and/or a cache memory.

13. A method for training an artificial neural network (ANN) for operation by a method including: defining, within the ANN, to be executed multiple times, at least one iterative block including one or more layers; defining number J of iterations, which is a maximum number of times the iterative block is to be executed; mapping an input of the iterative block onto an output, by the iterative block; supplying the output of the iterative block to the iterative block again as the input of the iterative bock, which is, in turn, mapped onto a new output by the iterative block; supplying by the iterative block, once the iterations of the iterative block have been completed, the output delivered by the iterative, as an input, to a layer of the ANN succeeding the iterative block or as the output of the ANN; wherein parameters that characterize a behavior of the layers in the iterative block are defined or modulated based on output of an auxiliary ANN that receives the following as inputs: (i) the input of the iterative block, and/or (ii) a processing product that is formed in a layer of the ANN which is downstream of the iterative block, and/or (iii) the parameters that characterize the behavior of the layers of the iterative block, and/or (iv) a continuous index of the iteration currently being executed by the iterative block, the method for training comprising:
providing learning inputs, and associated learning outputs onto which the ANN is to map the respective learning inputs;
mapping the learning inputs onto outputs by the ANN;
assessing a discrepancy between the outputs and the learning outputs, using a specified cost function; and
optimizing the parameters that characterize the behavior of the layers in the iterative block, including their changes at the time of switching between iterations, and/or parameters that characterize a behavior of the auxiliary ANN, such that, on further processing of learning inputs by the ANN, the assessment by the cost function is expected to have improved.

14. The method as recited in claim 13, wherein the cost function includes a contribution that depends on the number of parameters that is changed at the time of switching between iterations, and/or a rate of change of the changed parameters, and/or an absolute or relative change over all parameters.

15. The method as recited in claim 13, wherein, at the same time as and/or in alternation with the parameters that characterize the behavior of the layers in the iterative block, further parameters which characterize the behavior of further neurons and/or other processing units of the ANN outside the iterative block, are also optimized to an assessment by the cost function that is expected to be better.

16. A control device for a vehicle, comprising:
an input interface configured to be connected to one or more sensors of the vehicle;
an output interface configured to be connected to one or more actuators of the vehicle; and
an artificial neural network (ANN), the ANN taking part in processing of measurement data obtained over the input interface by the one or more sensors to give a control signal for the output interface;
wherein the control device is configured to operate the ANN, which processes inputs in a sequence of layers, to give outputs, the control device configured to:
define, within the ANN, to be executed multiple times, at least one iterative block including one or more layers;
define number J of iterations, which is a maximum number of times the iterative block is to be executed;
map an input of the iterative block onto an output, by the iterative block;
supply the output of the iterative block to the iterative block again as the input of the iterative bock, which is, in turn, mapped onto a new output by the iterative block;
supply by the iterative block, once the iterations of the iterative block have been completed, the output delivered by the iterative, as an input, to a layer of the ANN succeeding the iterative block or as the output of the ANN;
wherein parameters that characterize a behavior of the layers in the iterative block are defined or modulated based on output of an auxiliary ANN that receives the following as inputs:
the input of the iterative block, and/or
a processing product that is formed in a layer of the ANN which is downstream of the iterative block, and/or
the parameters that characterize the behavior of the layers of the iterative block, and/or
a continuous index of the iteration currently being executed by the iterative block.

17. A non-transitory machine-readable data carrier on which is stored a computer program for operating an artificial neural network (ANN), which processes inputs in a sequence of layers, to give outputs, the computer program, when executed by one or more computers, causing the one or more computers to perform the following steps:
defining, within the ANN, to be executed multiple times, at least one iterative block including one or more layers;
defining number J of iterations, which is a maximum number of times the iterative block is to be executed;
mapping an input of the iterative block onto an output, by the iterative block;
supplying the output of the iterative block to the iterative block again as the input of the iterative bock, which is, in turn, mapped onto a new output by the iterative block;
supplying by the iterative block, once the iterations of the iterative block have been completed, the output delivered by the iterative, as an input, to a layer of the ANN succeeding the iterative block or as the output of the ANN;
wherein parameters that characterize a behavior of the layers in the iterative block are defined or modulated based on output of an auxiliary ANN that receives the following as inputs:
the input of the iterative block, and/or
a processing product that is formed in a layer of the ANN which is downstream of the iterative block, and/or
the parameters that characterize the behavior of the layers of the iterative block, and/or
a continuous index of the iteration currently being executed by the iterative block.

18. A computer configured to operate an artificial neural network (ANN), which processes inputs in a sequence of layers, to give outputs, the computer configured to:
define, within the ANN, to be executed multiple times, at least one iterative block including one or more layers;
define number J of iterations, which is a maximum number of times the iterative block is to be executed;
map an input of the iterative block onto an output, by the iterative block;
supply the output of the iterative block to the iterative block again as the input of the iterative bock, which is, in turn, mapped onto a new output by the iterative block;
supply by the iterative block, once the iterations of the iterative block have been completed, the output delivered by the iterative, as an input, to a layer of the ANN succeeding the iterative block or as the output of the ANN;
wherein parameters that characterize a behavior of the layers in the iterative block are defined or modulated based on output of an auxiliary ANN that receives the following as inputs:
the input of the iterative block, and/or
a processing product that is formed in a layer of the ANN which is downstream of the iterative block, and/or
the parameters that characterize the behavior of the layers of the iterative block, and/or
a continuous index of the iteration currently being executed by the iterative block.
